(19) United States
(12) Patent Application Publication
(10) Pub. No.: US 2023/0342757 A1
(43) Pub. Date: Oct. 26, 2023

(54) DECENTRALIZED NETWORK SERVICES FOR CENTRALIZED NETWORK SERVICES

(71) Applicant: NCR Corporation, Atlanta, GA (US)

(72) Inventor: Bryan Walser Nonni, Atlanta, GA (US)

(21) Appl. No.: 17/725,682

(22) Filed: Apr. 21, 2022

(51) Int. Cl. G06Q 20/36; G06Q 20/06

(52) U.S. Cl. CPC G06Q 20/3678; G06Q 20/0658; G06Q 2220/00

(57) ABSTRACT

A Financial Institution (FI) funds a FI wallet with government-backed currency. The currency is transferred to an equivalent amount of United Stated Dollar (USD) coins. A customer of the bank utilizes an enhanced application (app) that permits value transfers between or associated with Centralized Financial (CeFi) services and Decentralized Financial (DeFi) services using the government-backed currency in the USD coins held by a cloud service and a cryptocurrency wallet held by the cloud service on behalf of the customer for value transfers associated with the DeFi services. Value transfers into and out of the cryptocurrency wallet is managed between interaction of the enhanced app, the cloud service, and the DeFi services. Value transfers into and out of the FI wallet is managed between interaction of the FI, the enhanced app, and the cloud service.

### BACKGROUND

The world of Decentralized Finance (DeFi) is exploding with new technologies and products offering the most competitive Returns on Investments (ROIs) to consumers in 40 years. Consumers can now get yield rates in the double digits by leveraging DeFi protocols such as Maker®, AAve®, Compound®, Alchemix®, or Yearn.fi® to name only a few. These protocols offer these high yields on various cryptocurrencies that can be volatile; however, almost all offer similar yields on United Stated Dollar (USD)-pegged stabled coins. Consumers can hedge volatility risk and simultaneously earn 10%+ on their dollar.

As a result, consumers are discovering these options and moving away from traditional Centralized Finance (CeFi). In fact, Financial Institutions (FIs) are missing out on a large debt and finance market available through the Blockchain (BC) and cryptocurrency environments. DeFi technology is rapidly emerging and providing very attractive financial products with high Annualized Percent Yields (APY) for consumers on their cryptocurrencies and stable coins. DeFi investments have reach an all-time high at $105 billion dollars invested into the BC and cryptocurrency ecosystem via smart contracts on various Ethereum®-based BCs. A year or so ago, in October of 2020, this investment total was just $21 billion dollars. For comparison, in the third quarter (Q3) of 2020, the total U.S. credit card debt was $807 billion dollars. The DeFi ecosystem is now ⅛^{th} of the total U.S. credit card debt. The implication is that this market will continue to grow and as it does, it will continue to exclude CeFi FI who will be losing millions to billions of dollars in lost debt serving, loan servicing, and investment servicing.

In many cases CeFi FIs are excluded from participating in DeFi arrangements due to government regulations (which prohibit direct cryptocurrency involvement by the FIs) and their own risk tolerances. Thus, FIs can only lobby to change the regulations and are forced to sit back and watch the consumer shift away from FIs towards the DeFi ecosystem.

### SUMMARY

In various embodiments, methods and a system for decentralized network services for centralized network services are presented.

According to an embodiment, a method for decentralized network services for centralized network services. Specifically, and in one embodiment, first funds of a Financial Institution (FI) are managed via a FI custodial wallet. Second funds of a customer of the FI are managed via a customer custodial wallet. Decentralized Financial (DeFi) services associated with cryptocurrencies of a blockchain (BC) are integrated into a FI application (app) used by the customer for Centralized Financial (CeFi) services of the FI by utilizing the FI custodial wallet, the customer custodial wallet, and ledgers.

### BRIEF DESCRIPTION OF THE DRAWINGS

FIG. 1 is a diagram of a system for decentralized network services for centralized network services, according to an example embodiment.

FIG. 2 is a diagram of a method for decentralized network services for centralized network services, according to an example embodiment.

FIG. 3 is a diagram of another method for decentralized network services for centralized network services, according to an example embodiment.

### DETAILED DESCRIPTION

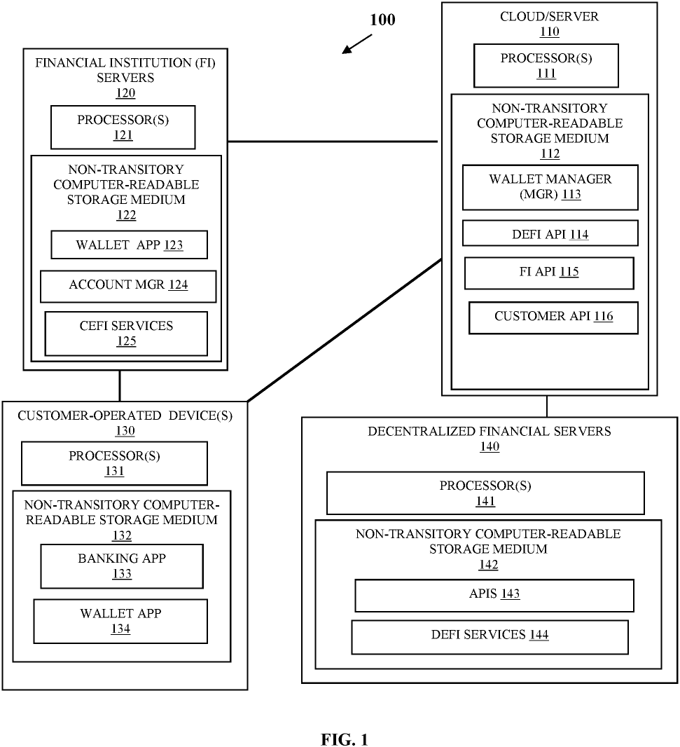

FIG. 1 is a diagram of a system 100 for decentralized network services for centralized network services, according to an example embodiment. The system 100 is shown schematically in greatly simplified form, with only those components relevant to understanding of one or more embodiments (represented herein) being illustrated. The various components are illustrated, and the arrangement of the components is presented for purposes of illustration only. It is to be noted that other arrangements with more or less components are possible without departing from decentralized network services for centralized network services teachings presented herein and below.

Moreover, various components are implemented as one or more software modules, which reside in non-transitory storage and/or hardware memory as executable instructions that when executed by one or more hardware processors perform the processing discussed herein and below.

System 100 provides verifiable techniques by which customer-operated devices and financial institution (FI) servers interact with a cloud for purposes of polling together and integrated funds associated with CeFi services and DeFi services. Traditional or existing mobile banking applications or websites are enhanced to provide access to nonconventional crypto-based DeFi services. Funds can be freely moved from existing CeFi FI institution accounts to DeFi digital wallets (accounts) and vice versa.

The CeFi institutions do not hold nor are they exposed to the risks associated with DeFi services, but they do permit customers to move government-backed currency from accounts into DeFi wallets for purposes of investing in and/or lending the government-backed currency in their accounts via DeFi services. Moreover, crypto funds held in DeFi wallets can be freely redeemed and deposited for use in conventional CeFi services.

The Cloud uses an Application Programming Interface (API) to interact with the protocols associated with other APIs of the DeFi services. The cloud pools together funds for customers of a given FI into a custodial FI wallet and maintains a ledger identifying the balances of each customer for the FI, which maps to specific accounts of the customers with the FI. Deposited funds from a given FI are purchased over the BC by the cloud as USD coins, which map directly to the value of the dollar and are held in the custodial FI wallet, such that the funds are redeemable whenever needed by the FI as government-backed currency.

Individual consumers of the bank can then use their enhanced banking app 133 to authorizing funds in a financial account with a FI to be moved to a cryptocurrency investment wallet using a wallet app associated with the banking app. The cloud creates a custodial customer wallet for the customer with the cloud, the corresponding funds from the custodial FI wallet are moved by the cloud to the customer’s custodial cryptocurrency wallet and ledgers are updated to reflect the withdrawal, such that the original. The cloud actually maintains a single wallet for the FIs and their individual accounts with USD coins as custodial FI wallets to ensure the funds are non-volatile and available when requested by any given FI. Moreover, the cloud maintains a single wallet for DeFi services of customers pooled together and managed by the cloud as individual custodial cryptocurrency wallets for the customers. Ledgers maintained by the cloud ensure that the exact balances held by each FI and each customer of the FIs are up-to-date with the proper media value (USD coins and cryptocurrency coins by cryptocurrency type).

Consumers use their enhanced banking apps to move government-backed currency out of savings or checking accounts into the selected DeFi services 144. This causes the cloud to withdraw the corresponding fund amounts in USD coins from the custodial FI wallet and move the funds into the custodial cryptocurrency (DeFi) wallet with the funds identified as belonging with the customer custodial wallet. The DeFi service desired by the customer (such as lending, saving, investing, borrowing, etc.) can then be selected from the enhanced banking application using the customer’s custodial wallet with the cloud. The cloud uses the pooled DeFi wallet for the customers to obtain the funds needed for the DeFi service, uses the API, and invests the funds with the DeFi service as directed by the customer and updates the ledgers and the customer’s custodial wallet to reflect the investment of the funds in the DeFi service. As returns on the investment are realized or accumulate, the pooled DeFi wallet is updated, and the ledger adjustments cause the customers custodial wallet to reflect the updates. When the customer logs into their enhanced banking app, funds held with the CeFi services of the FI are shown as they normally would be, and funds held with DeFi services are also shown via a summary and detailed listing of the customer’s custodial wallet provided by the cloud to the enhanced banking application.

The FI is never in any possession of any cryptocurrency, such that governmental compliance is maintained by the FI. Moreover, funds of the FI are not subject to volatility as the funds are held in USD coins are are always available for the FI to retrieve when needed. Customers of the FI can knowingly move government-backed currency from CeFi services to DeFi services the fund movements, gains, and losses are available within the enhanced banking app along with the full ledger of activity, such that volatility with the DeFi services are managed by the customers. In this way, FIs can allow their customers to get the benefit of both stable CeFi services and the potential gains associated with DeFi services through their enhanced banking app and via interaction with the cloud that provides the integration. In an embodiment, service or transaction fees for DeFi services can be collected by the cloud from the customer’s custodial wallet. In an embodiment, a portion of these fees may be provided back to the FI as an enticement for the FI to integrate the cloud and its integrated CeFi and DeFi services.

As used herein “valuable media” refers to any government-backed currencies and/or cryptocurrencies (Bitcoin®, Ethereum®, Dodgecoin®, Chainlink®, Litecoin, USD coin, etc.). A “value transfer” refers to a transfer of valuable media.

CeFi and DeFi services refer to investing, lending, or borrowing valuable media. CeFi services are offered from FIs via FI servers whereas DeFi services are offered from DeFi-based institutions via their APIs and servers.

It is within these contexts that system 100 and methods 200-300 are now discussed with reference to FIGS. 1-3.

System 100 comprises a cloud/server 110, FI servers 120, customer-operated devices 130, and decentralized financial servers 140.

Cloud/Server 110 comprises at least one processor 111 and a non-transitory computer-readable storage medium 112. Medium 112 comprises executable instructions for a wallet manager 113, a DeFi Application Programming Interface (API) 114, a FI API 115, and customer API 116. When the processor 111 obtains or is provided the executable instructions from medium 112, this causes the at processor 111 to perform the operations discussed herein and below with respect to 113-116.

Each FI 120 at least one processor 121 and a non-transitory computer-readable storage medium 122. Medium 122 comprises executable instructions for a wallet application (app) 123, an account manager 124, and a variety of CeFi services 125. When the processor 121 obtains or is provided the executable instructions from medium 122, this causes the at processor 121 to perform the operations discussed herein and below with respect to 123-125.

Each customer-operated device 130 comprises at least one processor 131 and a non-transitory computer-readable storage medium 132. Medium 132 comprises executable instructions for a banking app 133 and a wallet app 134. When the processor 131 obtains or is provided the executable instructions from medium 132, this causes the at processor 131 to perform the operations discussed herein and below with respect to 133-134.

Each decentralized financial server (node) 140 comprises at least one processor 141 and a non-transitory computer readable storage medium 142. Medium 140 comprises executable instructions for APIs 143 and a plurality of DeFi services 144. When the executable instructions are provided to corresponding processor 141 from medium 142, this causes processor 141 to perform operations discussed herein and below for 143-144.

System 100 uses a layer on top of existing DeFi services and the BC through value transfers between CeFi services 125 and DeFi services 144 are achieved, managed, and integrated with a banking app 133 of a given FI. A “customer” can be an individual, a business entity, such as a retailer, a governmental entity, or a for profit or non-profit organization.

Initially, an existing banking app is enhanced as a new banking app 133 that includes processing for maintaining and interacting with a wallet app 134. The wallet app 134 interacts through an API with wallet manager 113. FI servers 120 are enhanced to include a wallet app 123 that interacts with account manager 124, and wallet app 123 interacts with wallet manager 113 through an API.

A FI is registered with for a custodial wallet via wallet app 123. Funds held in savings, checking, and/or money markets can be deposited into the custodial wallet using wallet app 123 through interaction with wallet manager 113. Wallet manager 113 credits the individual custodial wallet of each FI with the funds they transferred and purchases stable USD coins to fund a FI pooled wallet on cloud 110. Details associated with the initial funding of the custodial wallet, such as account number for the corresponding customer and balance are managed in a ledger by wallet manager 113. For example, if $100,000 is transferred by a given FI to fund the custodial wallet and $70,000 is from account A with $30,000 from account B. Wallet manager 113 maintains a single pooled wallet having 100,000 USD coins with a ledger showing 70,000 USD coins belong with account A and 30,000 USD coins below with account B. Account manager 124 may also include a ledger indicating the funds belonging to accounts A and B are held in the custodial FI wallet accessible from wallet app 123. Interaction between FI server 120 and cloud 100 occurs via FI API 115.

A customer having the newly enhanced banking app 133 logs into FI server 120 when opening app 133 through the user-facing interface of app 133. This causes customer API 116 to present user-facing interface options to the customer for investing or borrowing from available DeFi services 144 (identified and obtained by cloud 110 through DeFi API 114). The customer is also presented an option for creating a custodial wallet via wallet app 134. The customer creates a custodial wallet via interaction between the user-facing interface of app 133, wallet app 134, and wallet manager 114 using customer API 116. Once the customer custodial wallet is created for the customer, the customer may fund the custodial wallet utilizing any of the funds available from the customer’s existing CeFi services 125 and their accounts for purpose of purchasing or investing in any of the DeFi services 144. In an embodiment, the customer may also use a personal digital wallet of the customer that currently has cryptocurrency valuable media and transfer any such funds to the newly created customer custodial wallet.

When a value transfer is performed via 100 133 for purposes of funding the custodial wallet, the custodial wallet is near instantaneously funded with current existing cryptocurrency valuable media held in a pooled single customer wallet by wallet manager 113 by updating a ledger maintained with the funds indicating that the funds in the pooled customer wallet below to the customer’s custodial wallet. Any actual BC operations needed to obtain the funds in the pooled customer wallet are performed or initiated and properly reflected within the pooled customer wallet once the BC operations confirm the transfer. For any initial funding of the customer custodial wallet that utilizes accounts associated with the CeFi services 125, wallet manager 113 obtains the USD coins representing the amount of funds from the pooled FI wallet, initiates and BC operations needed to sell the USD coins and buy the customer-desired cryptocurrency, flags the cryptocurrency type and amount within the pooled customer wallet, and updates the ledgers associated with the pooled FI wallet, the pooled wallet, the FI custodial wallet, and the custodial customer wallet.

At this point, the FI custodial wallet’s ledger shows a withdraw by the customer for the amount from the corresponding customer account, wallet app 123 reports the ledger entry to account manager 124, and account manager updates the account of the customer with the corresponding CeFi service 125. This causes banking app 133 to refresh showing the withdrawn amount from the account of the CeFi service 125 and showing the deposited amount in the cryptocurrency type and equivalent amount for the corresponding DeFi service 144 that the customer selected or purchased using the original funds of the account for the CeFi service 125.

The DeFi service 144 selected may be the customer lending a specific amount to a borrower (institution or a specific individual) at an agreed interest rate and term of interest. In such a situation, the wallet app 134 shows the amount as a negative amount along with the terms of the loan with the account services page of app 133 to the customer.

As return is realized from the DeFi services, such as agreed interest rate, loan payments with agreed interest, asset value increases or decreases (current market value of a given cryptocurrency), this is reflected within app 133 to the customer during a session and/or when logged into app 133. Wallet manager 113 reports the valuable media amounts in the valuable media types to DeFi app 114, DeFi app 114 interacts with the corresponding APIs 143 of the corresponding DeFi services 144 obtains the return and updates wallet app 134 accordingly. In this way, the customer sees real-time results.

Even when the customer is not logged into and does not have a session with app 133, the DeFi services when receiving loan payments, making interest payments, or remoting decreased or increased values in a cryptocurrency type will automatically update the pooled customer wallet managed by wallet manager 113. These updates are properly credited or debited to the corresponding customer custodial wallet via the ledger and are immediately available through wallet app 134 and banking app 133.

System 100 presents a great number of beneficial possibilities for consumers. For example, a consumer can deposit funds for a given cryptocurrency into the custodial wallet as bitcoin and uses a given DeFi service 144 that provides a USD cash loan for the amount of the bitcoin at agreed to terms. The Defi service 144 returns USD coins to the customer custodial wallet, which the customer transfers to a checking account associated with a checking CeFi service 125 of the customers FI using app 133. The customer then write a check for purchasing a new car from the checking account. Notice that the customer has not underwent a tax even for purposes of taxes because the customer never cashed out the bitcoin it is being held as collateral by the DeFi service 144 for repayment of a loan. This is but one example of many possible with system 100.

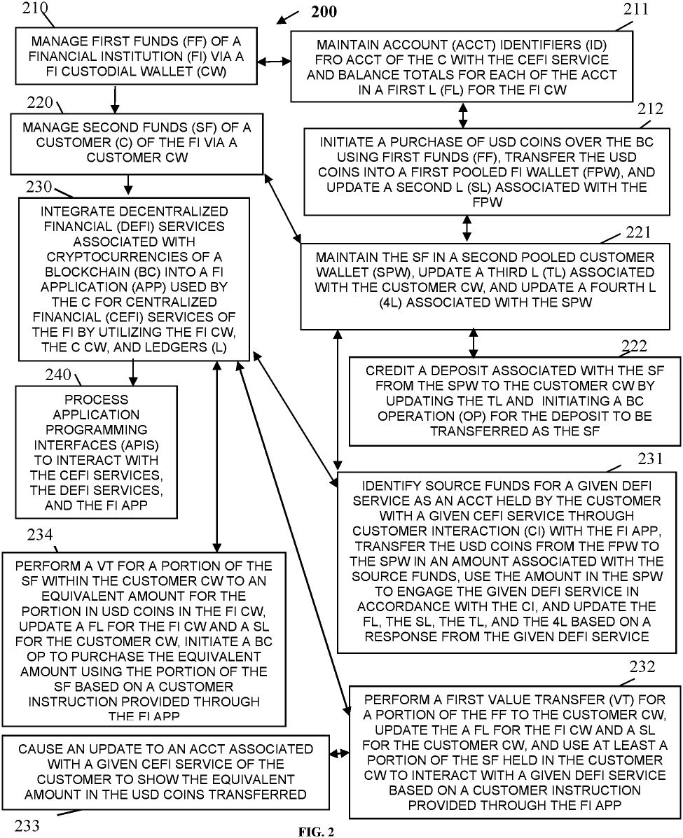

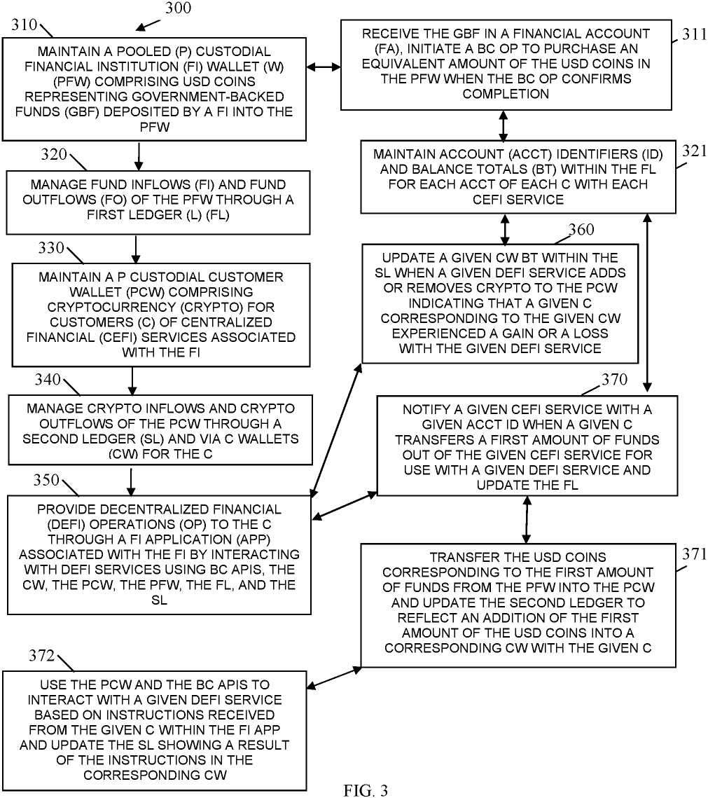

The embodiments of FIG. 1 and other embodiments are now discussed with reference to the FIGS. 2-3.

FIG. 2 is a diagram of a method 200 for decentralized network services for centralized network services, according to an example embodiment. The software module(s) that implements the method 200 is referred to as a “CeFi and DeFi integrator.” The CeFi and DeFi integrator is implemented as executable instructions programmed and residing within memory and/or a non-transitory computer-readable (processor-readable) storage medium and executed by a plurality of hardware processors of a plurality of hardware computing devices. The processors of the devices that execute the CeFi and DeFi integrator are specifically configured and programmed to process the CeFi and DeFi integrator. The CeFi and DeFi integrator has access to one or more networks during its processing. The networks can be wired, wireless, or a combination of wired and wireless.

In an embodiment, the devices that execute the CeFi and DeFi integrator is cloud 110 and/or server 110.

In an embodiment, the CeFi and DeFi integrator is all or some combination of 113, 114, 115, 116, 123, 133, and/or 134, discussed above with system 100.

At 210, the CeFi and DeFi integrator manages first funds of a FI via a first custodial wallet.

In an embodiment, at 211, the CeFi and DeFi integrator maintains account identifiers of customers for accounts of the customers with CeFi services 125 and balance totals for each of the accounts in a first ledger for the FI custodial wallet.

In an embodiment of 211 and at 212, the CeFi and DeFi integrator initiates a purchase of USD coins over a BC using first funds, transfers the USD coins into a first pooled FI wallet, and updates a second ledger associated with the first pooled FI wallet. The initial first funds may be received as government-backed currency into a financial account associated with the CeFi and DeFi integrator (or cloud 110), the funds are near instantaneously available from the FI custodial wallet as cloud 110 maintains a buffer of funds in the financial account and in the first pooled FI wallet. So, the FI experiences now BC-related delay for access to the funds. Moreover, the USD coins are a type of cryptocurrency but track directly to the value of the U.S. dollar such that there is no significant risk of devalue and the funds are stable.

At 220, the CeFi and DeFi integrator manages second funds of a customer for the FI via a customer custodial wallet.

In an embodiment of 212 and 220, at 221, the CeFi and DeFi integrator maintains the second funds in a second pooled customer wallet, updates a third ledger associated with the customer custodial wallet, and updates a fourth ledger associated with the second pooled customer wallet.

In an embodiment of 221 and at 222, the CeFi and DeFi integrator credits a deposit associated with the second funds for the second pooled customer wallet to the customer custodial wallet by updating the third ledger and initiating a BC operation for the deposit to be transferred as the second funds into the second pooled customer wallet.

At 230, the CeFi and DeFi integrator integrates DeFi services 144 associated with cryptocurrency of the BC into a FI app 133 used by the customer for CeFi services of the FI by utilizing the FI custodial wallet, the customer custodial wallet, and ledgers.

In an embodiment of 222 and 230, at 231, the CeFi and DeFi integrator identifies source funds for a given DeFi service 144 as an account held by the customer with a given CeFi service 125 through customer interaction with the FI app 133. The CeFi and DeFi integrator transfers the USD coins from the first pooled FI wallet to the second pooled customer wallet in an amount associated with the source funds. The CeFi and DeFi integrator uses the amount in the second pooled customer wallet to engage the given DeFi service 144 in accordance with the customer interaction or instructions and updates the first ledger, the second ledger, the third ledger and the fourth ledger based on a response from the given DeFi service 144 (the result detected by withdrawal or deposits of cryptocurrency within the second pooled customer wallet made by the given DeFi service 144).

In an embodiment, at 232, the CeFi and DeFi integrator performs a first value transfer for a portion of the first funds of the first pooled FI wallet to the customer custodial wallet, updates a first ledger for the FI custodial wallet and updates a second ledger for the customer custodial wallet, and the CeFi and DeFi integrator uses at least a portion of the second funds held in the customer custodial wallet to interact with a given DeFi service 144 based on a customer instruction provided through the FI app 133.

In an embodiment of 232 and at 233, the CeFi and DeFi integrator causes an update to an account associated with the given CeFi service 125 of the customer to show the equivalent amount in the USD coins transferred out of the FI custodial wallet based on the customer instruction provided through the FI app 133.

In an embodiment at 234, the CeFi and DeFi integrator performs a value transfer for a portion of the second funds within the customer custodial wallet to an equivalent amount for the portion in USD coins in the FI custodial wallet. The CeFi and DeFi integrator updates a first ledger for the FI custodial wallet and the updates a second ledger for the customer custodial wallet. The CeFi and DeFi integrator initiates a BC operation to purchase the equivalent amount using the portion of the second funds based on a customer instruction provided through the FI app 133.

In an embodiment of 234, the CeFi and DeFi integrator causes an update to an account associated with a given CeFi service 125 of the customer to show the equivalent amount in the USD coins transferred into the FI custodial wallet based on the customer instruction provided through the FI app 133.

FIG. 3 is a diagram of another method 300 for decentralized network services for centralized network services, according to an example embodiment. The software module(s) that implements the method 300 is referred to as a “CeFi and DeFi app integration service.” The CeFi and DeFi app integration service is implemented as executable instructions programmed and residing within memory and/or a non-transitory computer-readable (processor-readable) storage medium and executed by one or more hardware processors of one or more hardware devices. The processors of the devices that execute the CeFi and DeFi app integration service are specifically configured and programmed to process the CeFi and DeFi app integration service. The CeFi and DeFi app integration service has access to one or more networks during its processing. The networks can be wired, wireless, or a combination of wired and wireless.

The CeFi and DeFi app integration service presents another and, in some ways, enhanced processing perspective of that which was described above with the method 200.

In an embodiment, cloud 110 executes the CeFi and DeFi app integration service.

In an embodiment, the CeFi and DeFi app integration service is all or some combination of 113, 114, 115, 116, 123, 133, 134, and/or method 200.

At 310, the CeFi and DeFi app integration service maintains a pooled custodial FI wallet comprising USD coins representing government-backed funds deposited by a FI into the pooled custodial FI wallet.

In an embodiment, at 311, the CeFi and DeFi app integration service receives the government-backed funds into a financial account managed by the CeFi and DeFi app integration service, initiates a BC operation to purchase the equivalent amount of the USD coins in the pooled custodial FI wallet when the BC operation confirms completion.

In an embodiment, at 320, the CeFi and DeFi app integration service manages fund inflows and fund outflows of the pooled custodial FI wallet through a first ledger.

In an embodiment of 311 and 320, at 321, the CeFi and DeFi app integration service maintains account identifiers and balance totals within the first ledger for each account of each customer with each CeFi service 125.

At 330, the CeFi and DeFi app integration service maintains a pooled custodial customer wallet comprising cryptocurrency for customers of CeFi services 125 associated with the FI.

At 340, the CeFi and DeFi app integration service manages cryptocurrency inflows and cryptocurrency outflows of the pooled custodial customer wallets through a second ledger via customer wallets for the customers.

At 350, the CeFi and DeFi app integration service provides DeFi operations to the customers through a FI app 133 associated with the FI by interacting with DeFi services 144 using BC APIs 114, the customer custodial wallets, the pooled customer custodial wallet, the pooled custodial FI wallet, the first ledger, and the second ledger.

In an embodiment of 321 and 350, at 360, the CeFi and DeFi app integration service updates a given customer custodial wallet balance total within the second ledger when a given DeFi service 144 adds or removes cryptocurrency to the pooled custodial customer wallet indicating that a give customer corresponding to the given customer custodial wallet experienced a gain or a lost with the given DeFi service 144.

In an embodiment of 321 and 350, at 370, the CeFi and DeFi app integration service notifies a given CeFi service 125 with a given account identifier when a given customer transfers a first amount of funds out of the given CeFi service 125 for use with a given DeFi service 144 and the CeFi and DeFi app integration service updates the first ledger.

In an embodiment of 370 and at 371, the CeFi and DeFi app integration service transfers the USD coins corresponding to the first amount of funds from the pooled custodial FI wallet into the pooled custodial customer wallet and updates the second ledger to reflect an addition of the first amount of the USD coins into a corresponding customer custodial wallet associated with the given customer.

In an embodiment of 371 and at 372, the CeFi and DeFi app integration service uses the pooled custodial customer wallet and the BC APIs 114 to interact with a given DeFi service 144 based on the instructions received from the given customer within the FI app 133 and the CeFi and DeFi app integration service updates the second ledger to show a result of the instructions in the corresponding customer custodial wallet.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
managing first funds of a Financial Institution (FI) via a FI custodial wallet;
managing second funds of a customer of the FI via a customer custodial wallet; and
integrating Decentralized Financial (DeFi) services associated with cryptocurrencies of a blockchain (BC) into a FI application (app) used by the customer for Centralized Financial (CeFi) services of the FI by utilizing the FI custodial wallet, the customer custodial wallet, and ledgers.

2. The method of claim 1, wherein managing the first funds further includes maintaining account identifiers for accounts of the customer with the CeFi services and balance totals for each of the accounts in a first ledger maintained for the FI custodial wallet.

3. The method of claim 2, wherein maintaining further includes initiating a purchase United States Dollar (USD) coins over the BC using the first funds, transferring the USD coins into a first pooled FI wallet, and updating a second ledger associated with the first pooled FI wallet.

4. The method of claim 3, wherein managing the second funds further includes maintaining the second funds in a second pooled customer wallet, updating a third ledger associated with the customer custodial wallet, and updating a fourth ledger associated with the second pooled customer wallet.

5. The method of claim 4, wherein managing the second funds further includes crediting a deposit associated with the second funds from the second pooled customer wallet to the customer custodial wallet by updating the third ledger, initiating a BC operation on the BC for the deposit to be transferred as the second funds to the second pooled customer wallet, and updating the fourth ledger when the BC operation confirms completion of transfer.

6. The method of claim 4, wherein integrating further includes identifying source funds for a given DeFi service as an account held by the customer with a given CeFi service through customer interaction with the FI app, transferring the USD coins from the first pooled FI wallet to the second pooled customer wallet in an amount associated with the source funds, using the amount in the second pooled customer wallet to engage the given DeFi service in accordance with customer instructions, and updating the first ledger, the second ledger, the third ledger and the fourth ledger based on a response from the given DeFi service.

7. The method of claim 1, wherein integrating further includes performing a first value transfer for a portion of the first funds to the customer custodial wallet, updating a first ledger for the FI custodial wallet and a second ledger for the customer custodial wallet, and using at least a portion of the second funds held in the customer custodial wallet to interact with a given DeFi service based on a customer instruction provided through the FI app.

8. The method of claim 7, wherein performing further includes causing an update to an account associated with a given CeFi service of the customer to show the portion of the first funds transferred out of the FI custodial wallet based on the customer instruction provided through the FI app.

9. The method of claim 1, wherein interacting further includes performing a value transfer for a portion of the second funds within the customer custodial wallet to an equivalent amount for the portion in United States Dollar (USD) coins in the FI custodial wallet, updating a first ledger for the FI custodial wallet and a second ledger for the customer custodial wallet, and initiating a BC operation to purchase the USD coins in the equivalent amount using the portion of the second funds based on a customer instruction provided through the FI app.

10. The method of claim 9, wherein performing further includes causing an updated to an account associated with a given CeFi service of the customer to show the equivalent amount in the USD coins transferred into the FI custodial wallet based on the customer instruction provided through the FI app.

11. The method of claim 1 further comprising, processing Application Programming Interfaces (APIs) to interact with the CeFi services, the DeFi services, and the FI app.

12. A method, comprising:
maintaining a pooled custodial Financial Institution (FI) wallet comprising United States Dollar (USD) coins representing government-backed funds deposited by a FI into the pooled custodial FI wallet;
managing fund inflows and fund outflows of the pooled custodial FI wallet through a first ledger;
maintaining a pooled custodial customer wallet comprising cryptocurrency for customers of Centralized Financial (CeFi) services associated with the FI;
managing cryptocurrency inflows and cryptocurrency outflows of the pooled custodial customer wallet through a second ledger and via customer wallets for the customers; and
providing Decentralized Financial (DeFi) operations to the customers through a FI application (app) associated with the FI by interacting with DeFi services using Blockchain (BC) Application Programming Interfaces (API), the customer wallets, the pooled custodial customer wallet, the pooled custodial FI wallet, the first ledger, and the second ledger.

13. The method of claim 12, wherein maintaining the pooled custodial FI wallet further comprises, receiving the government-backed funds in a financial account, initiating a BC operation to purchase an equivalent amount of the USD coins, and receiving the USD coins in the pooled custodial FI wallet when the BC operation confirms completion.

14. The method of claim 13, wherein managing the fund inflows and the fund outflows further includes maintaining account identifiers and balance totals within the first ledger for each account of each customer with each CeFi service.

15. The method of claim 14 further comprising, updating a given customer wallet balance total within the second ledger when a given DeFi service adds or removes cryptocurrency to the pooled custodial customer wallet indicating that a given customer corresponding to the given customer wallet experienced a gain or a loss with the given DeFi service.

16. The method of claim 14 further comprising, notifying a given CeFi service with a given account identifier when a given customer transfers a first amount of funds out of the given CeFi service for use with a given DeFi service and updating the first ledger.

17. The method of claim 16, wherein notifying further includes transferring the USD coins corresponding to the first amount of funds from the pooled custodial FI wallet into the pooled custodial customer wallet and updating the second ledger to reflect an addition of the first amount of USD coins into a corresponding customer wallet for the given customer.

18. The method of claim 17, wherein transferring further includes using the pooled custodial customer wallet and the BC APIs to interact with a given DeFi service based on instructions received from the given customer within the FI app and updating the second ledger showing a result of the instructions in the corresponding customer wallet.

19. A system comprising:
a cloud comprising a plurality of servers;
each server comprising at least one processor and a non-transitory computer-readable storage medium;
each non-transitory computer-readable storage medium comprising executable instructions;
the executable instructions when provided to or obtained by the corresponding processor from the corresponding non-transitory computer-readable storage medium cause the corresponding processor to perform operations, comprising :
maintaining a pooled Financial Institution (FI) wallet on behalf of FIs using a first ledger and a custodial FI wallets for each FI;
maintaining linkages between balance totals for accounts of customers with Centralized Financial (CeFi) services associated with the FIs with funds in each of the custodial FI wallets and the pooled FI wallet within the first ledger;
maintaining a pooled customer wallet on behalf of the customers using a second ledger and custodial customer wallets for each of the customers; and
providing Decentralized Financial (DeFi) operations to the customers within FI applications (apps) associated with the FIs that permit the customers to perform value transfers between the accounts and the custodial customer wallets, and that permit the customers to perform additional value transfers between the custodial customer wallets and DeFi services using Blockchain (BC) Application Programming Interfaces (APIs) to perform the BC operations and using the pooled FI wallet, the custodial FI wallets, the pooled customer wallet, the custodial customer wallets, the first ledger, and the second ledger.

20. The system of claim 19, wherein the executable instructions when provided to or obtained by the corresponding processor from the corresponding non-transitory computer-readable storage medium further cause the corresponding processor to perform additional operations, comprising:
detecting cryptocurrency transferred into or out of the pooled customer wallet by a given DeFi service;
updating the second ledger to reflect the cryptocurrency and updating the corresponding custodial customer wallet associated with the given DeFi service to reflect the cryptocurrency; and
pushing an update during a session between a given customer and a given FI app that reflects the cryptocurrency added or removed from the corresponding custodial customer wallet of the given customer based on the detecting.
